(19) United States
(12) Patent Application Publication
(10) Pub. No.: US 2025/0258542 A1
(43) Pub. Date: Aug. 14, 2025

(54) ELECTRONIC DEVICE AND METHOD FOR PROVIDING UI THEREOF

(71) Applicant: SAMSUNG ELECTRONICS CO., LTD., Suwon-si (KR)

(72) Inventors: Sangjin HAN, Suwon-si (KR); Yonghwan KWON, Suwon-si (KR); Hyeonji LEE, Suwon-si (KR); Junggeun KIM, Suwon-si (KR)

(73) Assignee: SAMSUNG ELECTRONICS CO., LTD., Suwon-si (KR)

(21) Appl. No.: 19/193,324

(22) Filed: Apr. 29, 2025

Related U.S. Application Data
(63) Continuation of application No. PCT/KR2023/014272, filed on Sep. 20, 2023.

(30) Foreign Application Priority Data
Nov. 8, 2022 (KR) 10-2022-0147966

(51) Int. Cl. G06F 3/01; G06F 3/04845; G06F 3/0485

(52) U.S. Cl. CPC G06F 3/013; G06F 3/04845; G06F 3/0485; G06F 2203/04803; G09G 2354/00

(57) ABSTRACT

An electronic device comprises: a display that is rotatable; a camera; a memory. The at least one processor is connected to the display, the camera, and the memory so as to control the electronic device to operate in one of a landscape mode and a portrait mode. The at least one processor is configured to identify a user's gaze position and a distance between the electronic device and the user, on the basis of a captured image obtained through the camera; identify a viewing angle area corresponding to a current display mode of the electronic device from among display areas of the display on the basis of the user's gaze position and the distance between the electronic device and the user; and control the display to display a guide UI to allow adjustment of the viewing angle area when the identified viewing angle area is outside viewing angle area.

### CROSS-REFERENCE TO RELATED APPLICATION

This application is a continuation application is a continuation application, under 35 U.S.C. § 111(a), of international application No. PCT/KR2023/014272, filed Sep. 20, 2023, which claims priority under 35 U.S.C. § 119 to Korean Patent Application No. 10-2022-0147966, filed Nov. 8, 2022, the disclosures of which are incorporated herein by reference in their entireties.

### BACKGROUND

### 1. Field

The disclosure relates to an electronic device and a method for providing a UI thereof, and more particularly, to an electronic device wherein a screen is rotated, and a method for providing a UI thereof.

### 2. Description of Related Art

Spurred by development of electronic technologies, various types of electronic devices are being developed and distributed. In particular, large size display devices such as a TV are being developed in various forms.

As an example, development of a display that provides a vertical type content by rotating a conventional screen in a horizontal direction to a vertical direction is actively going on.

### SUMMARY

An electronic device according to an embodiment includes a display that is rotatable, a camera, a memory to store at least one instruction, and at least one processor that is connected with the display, the camera, and the memory, and controls the electronic device to operate in one of a horizontal mode and a vertical mode. The at least one processor is configured, by executing the at least one instruction, based on a captured image obtained through the camera, identify a distance between the electronic device and a user, and a gaze position of the user, and based on the distance between the electronic device and the user, and the gaze position of the user, identify a viewing angle area corresponding to a current display mode of the electronic device among display areas of the display, and based on identifying that the identified viewing angle area is outside a threshold range based on a predetermined viewing angle area, control the display to display a guide UI to allow adjustment of the viewing angle area.

According to an embodiment, the at least one processor may, based on the current display mode of the electronic device being the horizontal mode, identify whether the identified viewing angle area is outside the threshold range based on a predetermined first viewing area, and based on the current display mode of the electronic device being the vertical mode, identify whether the identified viewing angle area is outside the threshold range based on a predetermined second viewing area. The guide UI may include a phrase guiding at least one of adjustment of the position of the user or adjustment of a height of a stand supporting the display.

According to an embodiment, the at least one processor may control the display to display a user interface (UI) screen wherein a plurality of scrollable graphic user interface (GUI) items are arranged in a line in a vertical direction in the identified viewing angle area. The at least one processor may, based on a focus GUI being a movable focus GI, control the display to display the movable focus GUI on a GUI item located in a center of the gaze position of the user among the plurality of GUI items. The at least one processor may, based on the focus GUI being a fixed focus GI, control the display to display a GUI item where a fixed GUI item is located among the plurality of GUI items in the center of the gaze position of the user.

According to an embodiment, the at least one processor may, based on the focus GUI being a movable focus GI, control the display such that a GUI item where the movable focus GUI is located, the location of which is moved based on a scroll input, is displayed in a center of the gaze position of the user. The at least one processor may, based on the focus GUI being a fixed focus GI, control the display to move the plurality of GUI items while the fixed focus GUI is fixed on the center of the gaze position of the user based on a scroll input, and display the GUI items.

According to an embodiment, the at least one processor may, based on the plurality of GUI items being items of a horizontal type, control the display such that the movable focus GUI is displayed on a horizontal type item located in the center of the gaze position of the user among the plurality of GUI items, and control the display such that a horizontal type item wherein the fixed focus GUI is located among the plurality of GUI items is displayed in the center of the gaze position of the user. The at least one processor may, based on the plurality of GUI items being items of a grid type, control the display such that the movable focus GUI is displayed on a grid type item included in a line located in the center of the gaze position of the user, and control the display such that a line including a grid type item wherein the fixed focus GUI is located is displayed in the center of the gaze position of the user.

According to an embodiment, the at least one processor may control the display to display a UI screen wherein a plurality of scrollable horizontal type GUI items are arranged in a line in a vertical direction in the identified viewing angle area, and based on the center of the gaze within the viewing angle area being located in an area lower than the center of the screen, control the display to display the plurality of horizontal type GUI items by inversing their order upside down, such that a horizontal type item wherein a fixed focus GUI is located among the plurality of horizontal type GUI items is arranged in the lower area of the screen.

According to an embodiment, the at least one processor may control the display to display a UI screen including a plurality of scrollable grid type GUI items in the identified viewing angle area, identify whether the center of the gaze position of the user is located within the viewing angle area in at least one area among the upper area, the lower area, the left area, and the right area based on the center of the screen, and based on the identification result, control the display to display the plurality of grid type GUI items by inversing the plurality of grid type GUI items in at least one of an upside-down direction or a left-right direction such that a grid type item wherein a fixed focus GUI is located among the plurality of grid type GUI items is arranged in an area close to the center of the gaze position of the user.

According to an embodiment, the at least one processor may adjust a size of a UI screen including a plurality of GUI items to be reduced based on the size of the identified viewing angle area, and control the display to display the UI screen in a reduced size within the viewing angle area.

According to an embodiment, the electronic device may further include a communication interface, and the at least one processor may, based on receiving a UI screen from an external source through the communication interface, control the display to display a guide UI inquiring whether to display the UI screen within the identified viewing angle area, and based on identifying a user instruction for displaying the received UI screen within the viewing angle area, adjust the received UI screen to be reduced, and control the display to display the UI screen in the reduced size within the viewing angle area.

According to an embodiment, the at least one processor may control the display to display a UI screen including a plurality of partial UI items, and based on identifying the viewing angle area, control the display to rearrange the plurality of partial UI items and display them within the identified viewing angle area.

A method for providing a UI of an electronic device that operates in one display mode between a horizontal mode and a vertical mode according to an embodiment may include, based on a captured image obtained through a camera, identifying a distance between the electronic device and a user, and a gaze position of the user, and based on the distance between the electronic device and the user, and the gaze position of the user, identifying a viewing angle area corresponding to a current display mode of the electronic device among display areas of the display, and based on identifying that the identified viewing angle area is outside a threshold range based on a predetermined viewing angle area, displaying a guide UI to allow adjustment of the viewing angle area.

In a non-transitory computer-readable medium storing computer instructions which, when executed by a processor of an electronic device that operates in one display mode between a horizontal mode and a vertical mode, cause the electronic device to perform operations according to an embodiment, the operations may include, based on a captured image obtained through a camera, identifying a distance between the electronic device and a user, and a gaze position of the user, and based on the distance between the electronic device and the user, and the gaze position of the user, identifying a viewing angle area corresponding to a current display mode of the electronic device among display areas of the display, and based on identifying that the identified viewing angle area is outside a threshold range based on a predetermined viewing angle area, displaying a guide UI to allow adjustment of the viewing angle area.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram for schematically illustrating an implementation example of an electronic device according to an embodiment of the disclosure;

FIG. 2A is a block diagram illustrating a configuration of an electronic device according to an embodiment;

FIG. 2B is a block diagram illustrating in detail a configuration of an electronic device according to an embodiment;

FIG. 3 is a diagram for illustrating a method of providing a UI screen according to an embodiment;

FIG. 4, FIG. 5A, and FIG. 5B are diagrams for illustrating a method of providing a UI screen according to an embodiment;

FIG. 6A, FIG. 6B, FIG. 7A, FIG. 7B, FIG. 8A and FIG. 8B are diagrams for illustrating a method of identifying a viewing angle of a user according to an embodiment;

FIG. 9A, 9B to FIG. 9C are diagrams for illustrating a method of providing a guide UI according to an embodiment;

FIG. 10, FIG. 11A, and FIG. 11B are diagrams for illustrating a method of providing a UI screen according to an embodiment;

FIG. 12, FIG. 13A, and FIG. 13B are diagrams for illustrating a method of providing a UI screen according to an embodiment;

FIG. 14A, 14B to FIG. 14C are diagrams for illustrating a method of providing a UI screen according to an embodiment;

FIG. 15 and FIG. 16 are diagrams for illustrating a method of providing a UI screen according to an embodiment;

FIG. 17 and FIG. 18 are diagrams for illustrating a method of providing a UI screen according to an embodiment;

FIG. 19A and FIG. 19B are diagrams for illustrating a method of providing a UI screen according to an embodiment;

FIG. 20, FIG. 21A, and FIG. 21B are diagrams for illustrating a method of providing a UI screen according to an embodiment;

FIG. 22A and FIG. 22B are diagrams for illustrating a method of providing a UI screen according to an embodiment;

FIG. 23A and FIG. 23B are diagrams for illustrating a method of providing a UI screen according to an embodiment; and

FIG. 24A and FIG. 24B are diagrams for illustrating a method of providing a guide UI according to an embodiment.

### DETAILED DESCRIPTION

Hereinafter, the disclosure will be described in detail with reference to the accompanying drawings.

First, terms used in this specification will be described briefly, and then the disclosure will be described in detail.

As terms used in the embodiments of the disclosure, general terms that are currently used widely were selected as far as possible, in consideration of the functions described in the disclosure. However, the terms may vary depending on the intention of those skilled in the art who work in the pertinent field or previous court decisions, or emergence of new technologies, etc. Also, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

In addition, in this specification, expressions such as “have,” “may have,” “include” and “may include” should be construed as denoting that there are such characteristics (e.g.: elements such as numerical values, functions, operations, and components), and the expressions are not intended to exclude the existence of additional characteristics.

Further, the expression “at least one of A and/or B” should be interpreted to mean any one of “A” or “B” or “A and B.”

Also, the expressions “first,” “second,” and the like used in this specification may describe various elements regardless of any order and/or degree of importance. Further, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

Also, the expression “configured to” used in the disclosure may be interchangeably used with other expressions such as “suitable for,” “having the capacity to,” “designed to,” “adapted to,” “made to” and “capable of,” depending on cases. Meanwhile, the term “configured to” may not necessarily mean that a device is “specifically designed to” in terms of hardware.

In addition, singular expressions include plural expressions, as long as they do not obviously mean differently in the context. Also, in the disclosure, terms such as “include” and “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

Further, in the disclosure, “a module” or “a part” performs at least one function or operation, and may be implemented as hardware or software, or as a combination of hardware and software. In addition, a plurality of “modules” or “parts” may be integrated into at least one module and implemented as at least one processor (not shown), except “a module” or “a part” that needs to be implemented as specific hardware.

Hereinafter, an embodiment of the disclosure will be described in more detail with reference to the accompanying drawings.

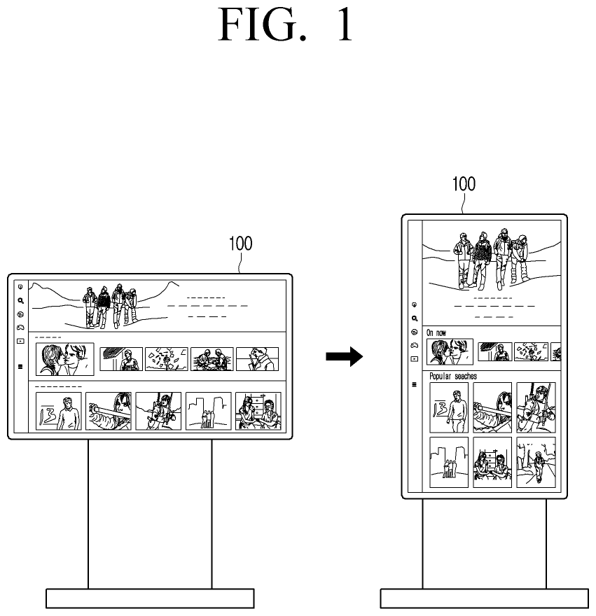

FIG. 1 is a diagram for schematically illustrating an implementation example of an electronic device according to an embodiment of the disclosure.

The electronic device 100 can be implemented as various devices equipped with a display function such as a monitor, a smart monitor, a smart TV, an electronic photo frame, an electronic board, an electronic table, a laptop, digital signage, a digital information display (DID), a video wall, a projector, a tablet PC, etc.

According to an embodiment, the electronic device 100 may operate in one display mode between a horizontal mode and a vertical mode as illustrated in FIG. 1. For example, the horizontal mode may be a display mode wherein the horizontal length of the display 110 is longer than the vertical length. Also, the vertical mode may be a display mode wherein the vertical length of the display 110 is longer than the horizontal length. Meanwhile, the horizontal mode may also be referred to as a horizontal direction posture mode or a landscape mode, and the vertical mode may also be referred to as a vertical direction posture mode or a portrait mode. According to an embodiment, the electronic device 100 may rotate the display 110 by using a pivot function. However, the display mode of the electronic device 100 does not operate only in the horizontal mode or the vertical mode, and the electronic device 100 may operate in a state of being tilted by a specific angle (e.g., a state of being obliquely tilted in a diagonal direction) according to a user instruction.

According to an embodiment, the electronic device 100 may be changed from the horizontal mode to the vertical mode, or changed from the vertical mode to the horizontal mode according to a user instruction. However, depending on cases, it is also possible that the display mode is changed automatically based on an image type, the surrounding environment, etc. For example, the electronic device 100 may receive a user instruction for changing the display mode from a user terminal and/or a remote control device that can be remotely controlled by using an application such as a smartphone, etc., or receive a user instruction for changing the display mode through a button provided on the electronic device 100, a user voice, a gesture, etc. The electronic device 100 may perform communication with a user terminal and/or a remote control through a communication method such as Wi-Fi communication, Bluetooth communication, infrared communication, etc.

According to an embodiment, the electronic device 100 may provide a user interface (UI) screen including a plurality of objects. For example, objects may have various sizes and/or various ratios. Here, an object may include various GUI elements such as a thumbnail, a representative image, an icon, a menu item, a title, a description, etc.

According to an embodiment, if the display mode of the electronic device 100 is changed from the horizontal mode to the vertical mode, a difference may occur in the UX experience of the user according to the change of the screen ratio. In particular, in case the electronic device 100 is implemented as a close range monitor, a case wherein the main content goes beyond the viewing angle of the user according to change of the display mode occurs, and thus there may be interference in the UX experience of the user according to the change of the screen ratio.

Accordingly, hereinafter, various embodiments wherein a user's main interaction is not made to go beyond the viewing angle area by arranging main information within the viewing angle area in consideration of the user's viewing angle in the horizontal mode and the vertical mode will be explained.

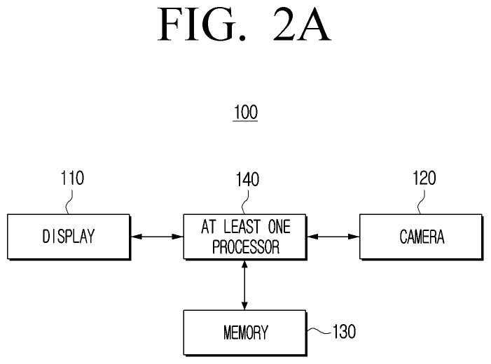

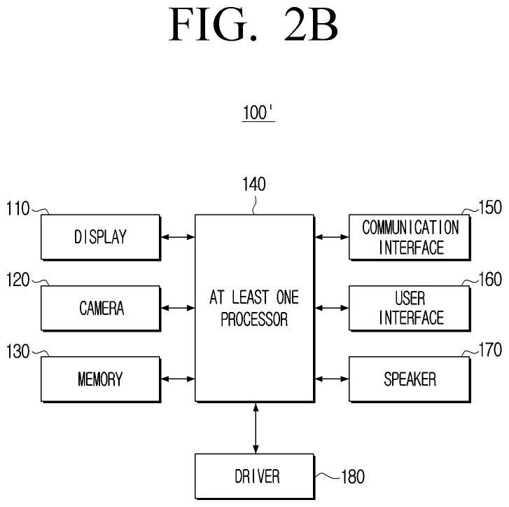

FIG. 2A is a block diagram illustrating a configuration of an electronic device according to an embodiment.

According to FIG. 2A, the electronic device 100 includes a display 110, a camera 120, memory 130, and at least one processor 140.

The display 110 may be implemented as a display including self-luminescence elements, or a displaying including non-self-luminescence elements and a backlight. For example, the display 110 may be implemented as various forms of displays such as a liquid crystal display (LCD), an organic light emitting diodes (OLED) display, light emitting diodes (LED), micro LED, mini LED, a plasma display panel (PDP), a quantum dot (QD) display, quantum dot light emitting diodes (QLED), etc. Inside the display 110, driving circuits that may be implemented in forms such as an a-si TFT, a low temperature poly silicon (LTPS) TFT, an organic TFT (OTFT), etc., and a backlight unit, etc. may also be included. According to an embodiment, on the front surface of the display 110, a touch sensor that is in a form such as a touch film, a touch sheet, a touch pad, etc., and detects a touch operation may be arranged, and implemented to detect various types of touch inputs. For example, the display 110 may detect various types of touch inputs such as a touch input by a user hand, a touch input by an input device such as a stylus pen, a touch input by a specific electrostatic material, etc. Here, an input device may be implemented as an input device of a pen type that can be referred to as various terms such as an electronic pen, a stylus pen, an S-pen, etc. According to an embodiment, the display 110 may be implemented as a flat display, a curved display, a flexible display that can be folded and/or rolled, etc.

The camera 120 may be turned on according to a predetermined event and perform capturing. The camera 120 may convert a captured image into an electric signal, and generate image data based on the converted signal. For example, a subject may be converted into an electric image signal through a semiconductor optical element (a charge coupled device (CCD)), and the image signal converted as such may be amplified and converted into a digital signal, and then go through signal processing. For example, the camera 120 may be implemented as a general camera, a stereo camera, a depth camera, etc.

According to an embodiment, the camera 120 may be arranged in the outer rim area of the display 110. For example, the camera 120 may be arranged in the center area of the upper part, the center area of the left part, or the center bezel area of the right part of the display 110, but the disclosure is not limited thereto.

The memory 130 may store data necessary for various embodiments. The memory 130 may be implemented in a form of memory embedded in the electronic device 100, or implemented in a form of memory that can be attached to or detached from the electronic device 100 according to the usage of stored data. For example, in the case of data for operating the electronic device 100, the data may be stored in memory embedded in the electronic device 100, and in the case of data for an extended function of the electronic device 100, the data may be stored in memory that can be attached to or detached from the electronic device 100. Meanwhile, in the case of memory embedded in the electronic device 100, the memory may be implemented as at least one of volatile memory (e.g.: dynamic RAM (DRAM), static RAM (SRAM), or synchronous dynamic RAM (SDRAM), etc.) or non-volatile memory (e.g.: one time programmable ROM (OTPROM), programmable ROM (PROM), erasable and programmable ROM (EPROM), electrically erasable and programmable ROM (EEPROM), mask ROM, flash ROM, flash memory (e.g.: NAND flash or NOR flash, etc.), a hard drive, or a solid state drive (SSD)). Also, in the case of memory that can be attached to or detached from the electronic device 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.), and external memory that can be connected to a USB port (e.g., a USB memory), etc.

The at least one processor 140 controls the overall operations of the electronic device 100. Specifically, the at least one processor 140 may be connected with each component of the electronic device 100, and control the overall operations of the electronic device 100. For example, the at least one processor 140 may be electrically connected with the display 110 and the memory 130, and control the overall operations of the electronic device 100. The processor 140 may consist of one or a plurality of processors.

The at least one processor 140 may perform the operations of the electronic device 100 according to the various embodiments by executing the at least one instruction stored in the memory 130.

The at least one processor 140 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The at least one processor 140 may control one or a random combination of the other components of the electronic device 100, and perform an operation related to communication or data processing. Also, the at least one processor 140 may execute one or more programs or instructions stored in the memory. For example, the at least one processor 140 may perform the method according to an embodiment of the disclosure by executing the at least one instruction stored in the memory.

In case the method according to an embodiment of the disclosure includes a plurality of operations, the plurality of operations may be performed by one processor, or performed by a plurality of processors. For example, when a first operation, a second operation, and a third operation are performed by the method according to an embodiment, all of the first operation, the second operation, and the third operation may be performed by a first processor, or the first operation and the second operation may be performed by the first processor (e.g., a generic-purpose processor), and the third operation may be performed by a second processor (e.g., an artificial intelligence-dedicated processor).

The at least one processor 140 may be implemented as a single core processor including one core, or may be implemented as one or more multicore processors including a plurality of cores (e.g., multicores of the same kind or multicores of different kinds). In case the at least one processor 140 is implemented as multicore processors, each of the plurality of cores included in the multicore processors may include internal memory of the processor such as cache memory, on-chip memory, etc., and common cache shared by the plurality of cores may be included in the multicore processors. Also, each of the plurality of cores (or some of the plurality of cores) included in the multicore processors may independently read a program instruction for implementing the method according to an embodiment of the disclosure and perform the instruction, or the plurality of entire cores (or some of the cores) may be linked with one another, and read a program instruction for implementing the method according to an embodiment of the disclosure and perform the instruction.

In case the method according to an embodiment of the disclosure includes a plurality of operations, the plurality of operations may be performed by one core among the plurality of cores included in the multicore processors, or they may be performed by the plurality of cores. For example, when the first operation, the second operation, and the third operation are performed by the method according to an embodiment, all of the first operation, the second operation, and the third operation may be performed by a first core included in the multicore processors, or the first operation and the second operation may be performed by the first core included in the multicore processors, and the third operation may be performed by a second core included in the multicore processors.

In the embodiments of the disclosure, the processor 140 may mean a system on chip (SoC) wherein at least one processor and other electronic components are integrated, a single core processor, a multicore processor, or a core included in the single core processor or the multicore processor. Also, here, the core may be implemented as a CPU, a GPU, an APU, a MIC, a DSP, an NPU, a hardware accelerator, or a machine learning accelerator, etc., but the embodiments of the disclosure are not limited thereto. However, hereinafter, the at least one processor 140 will be referred to as the processor 140, for the convenience of explanation.

FIG. 2B is a block diagram illustrating in detail a configuration of an electronic device according to an embodiment.

According to FIG. 2B, the electronic device 100′ may include a display 110, a camera 120, memory 130, at least one processor 140, a communication interface 150, a user interface 160, a speaker 170, and a driver 180. Among the components illustrated in FIG. 2B, regarding components overlapping with the components illustrated in FIG. 2A, detailed explanation will be omitted.

The communication interface 150 can obviously be implemented as various interfaces depending on implementation examples of the electronic device 100′. For example, the communication interface 150 may perform communication with an external device, an external storage medium (e.g., a USB memory), an external server (e.g., a webhard), etc. through communication methods such as Bluetooth, AP-based Wi-Fi (Wi-Fi, a wireless LAN network), Zigbee, a wired/wireless local area network (LAN), a wide area network (WAN), an Ethernet, the IEEE 1394, a high-definition multimedia interface (HDMI), a universal serial bus (USB), a mobile high-definition link (MHL), the Audio Engineering Society/European Broadcasting Union (AES/EBU), Optical, Coaxial, etc. Also, according to an embodiment, the communication interface 150 may perform communication with a user terminal and/or a remote control device.

The user interface 160 may be implemented as a device such as a button, a touch pad, a mouse, and a keyboard, or may be implemented as a touch screen that can perform the aforementioned display function and a manipulation input function together, etc.

The speaker 170 may be a component that outputs not only various kinds of audio data, but also various kinds of notification sounds or voice messages, etc. The processor 140 may control the speaker 170 to output information corresponding to UI screens according to the various embodiments of the disclosure or various kinds of notifications in audio forms.

The driver 180 may rotate the display 110. For example, the driver 180 may be connected to a gear coupled with the display 110 (e.g., a circular gear), and rotate the display 110 in a clockwise direction or a counter-clockwise direction by rotating the gear according to control by the processor 140. Alternatively, the driver 180 may stop the rotation of the display 110 by stopping the rotation of the gear according to control by the processor 140. The driver 180 may be implemented as various motors such as a step motor, a direct current (DC) electric motor, an alternating current (AC) electric motor, a brushless DC (BLDC) electric motor, etc.

Other than the above, the electronic device 100′ may include a microphone (not shown) and a sensor (not shown), etc. depending on implementation examples.

The microphone (not shown) is a component for receiving input of a user voice or other sounds, and converting them into audio data. However, according to another embodiment, the electronic device 100′ may receive a user voice input through an external device through the communication interface 150.

The sensor (not shown) may include various types of sensors such as a touch sensor, a proximity sensor, an acceleration sensor, a geomagnetic sensor, a gyro sensor, a pressure sensor, a position sensor, etc.

According to an embodiment, the processor 140 may control the driver 180 to operate in one display mode between the horizontal mode and the vertical mode.

According to an embodiment, the processor 140 may provide a UI screen including GUI items having various sizes and/or various ratios in the horizontal mode. Here, the GUI items may include various forms of images and/or texts corresponding to various types of contents such as an image content, a video content, an application, an advertising content, etc. For example, a GUI item may be a thumbnail representing the corresponding content, a representative image, a title, a description, etc., but it is not limited if it is a form by which the corresponding content can be identified.

According to an embodiment, the processor 140 may display GUI items in a horizontal type and/or a grid type. The horizontal type may mean providing GUI items in a form which is longer in the horizontal length by arranging them in a vertical direction, and the grid type may mean providing GUI items in a form of a square (or a rectangle) by arranging them in all four directions.

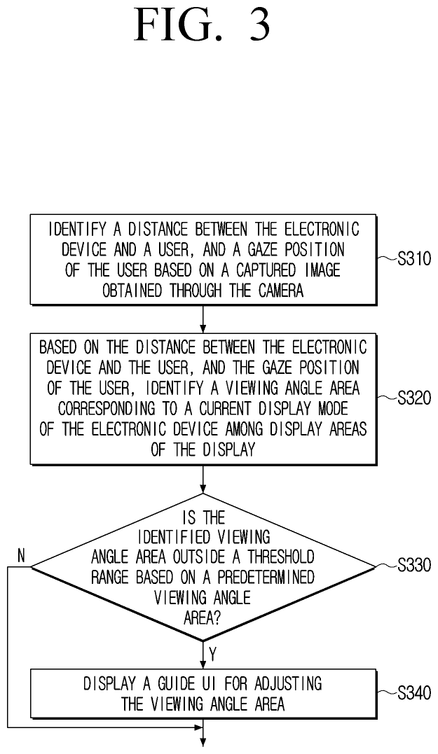

FIG. 3 is a diagram for illustrating a method of providing a UI screen according to an embodiment.

According to the embodiment illustrated in FIG. 3, the processor 140 may identify a distance between the electronic device 100 and a user, and a gaze position (or the position of the eyes) of the user based on a captured image obtained through the camera 120 in the operation S310.

According to an embodiment, in case the camera 120 is implemented as a depth camera, the processor 140 may automatically identify the distance between the electronic device 100 and the user (referred to as a viewing distance hereinafter) from an image captured from the camera 120. The processor 140 may also identify a viewing distance by another sensor (e.g., a distance sensor). However, the disclosure is not limited thereto, and a viewing distance can be implemented to be directly set by the user. For example, the user may set a viewing distance by using an on screen display (OSD) menu by which a viewing distance can be selected, buttons provided for each viewing distance on the remote control, etc.

According to an embodiment, the processor 140 may identify a gaze position of the user by detecting the position of the face of the user and detecting the position of the eyes included in the face area from a captured image.

As a method for detecting a face area, various conventional methods may be used. Specifically, a direct recognition method and a method using statistics may be used. In the direct recognition method, rules using physical characteristics such as the contour skin color and the sizes of components of a face image appearing on the screen or a distance between the components, etc. are made, and comparison, inspection, and measurement are performed according to the rules. In the method using statistics, a face area may be detected according to an algorithm learned in advance.

That is, it is a method of making unique characteristics included by an input face into data, and performing comparative analysis with a large amount of prepared databases (shapes of faces and other objects). In particular, a face area may be detected according to an algorithm learned in advance, and a method such as Multi Layer Perceptron (MLP) and Support Vector Machine (SVM) may be used. Also, through a face modeling technology, a gaze position of the user may be identified from a captured image. Here, the face modeling technology is an analysis process converting its characteristics into digital information for processing and transmission of a face image obtained by the camera 120 and one of an active shape modeling (ASM) technic or an active appearance modeling (AAM) technic may be used.

Then, the processor 140 may identify a viewing angle area corresponding to a current display mode of the electronic device 100 among display areas of the display 110 based on the viewing distance and the gaze position of the user in the operation S320. Here, the display mode may include the horizontal mode and the vertical mode.

Afterwards, if it is identified that the identified viewing angle area is outside a threshold range based on a predetermined viewing angle area in the operation S330:Y, the processor 140 may control the display 110 to display a guide UI for adjusting the viewing angle area in the operation S340. Here, the guide UI may include a phrase guiding at least one of adjustment of the position of the user or adjustment of the height of a stand supporting the display 110.

According to an embodiment, if a viewing angle is identified as a user is recognized for the first time, the processor 140 may immediately apply the identified viewing angle, and provide a guide UI for adjusting the viewing angle area (or a guide GUI for a viewing angle test). Afterwards, the processor 140 may identify a viewing angle as an average value by measuring for n seconds or more in consideration of a user movement.

According to an embodiment, the processor 140 may re-identify a viewing angle on every time point when the user is re-recognized even after the optimal viewing angle was applied according to a viewing angle test. Here, user re-recognition may be performed in case the user disappeared from the front side of the electronic device 100 and reappeared, and on a time point when the power of the electronic device 100 was turned on again, etc.

According to an embodiment, in case a re-identified viewing angle is different from the previous viewing angle by a threshold value or bigger, the processor 140 may apply the re-identified viewing angle on a time point of renewal of the screen. For example, if a viewing angle difference is generated between a re-identified viewing angle and the previous viewing angle by +−n% or more, the processor 140 may apply the re-identified viewing angle on a time point of renewal of the screen. Here, the n value may be set as different values for each screen size.

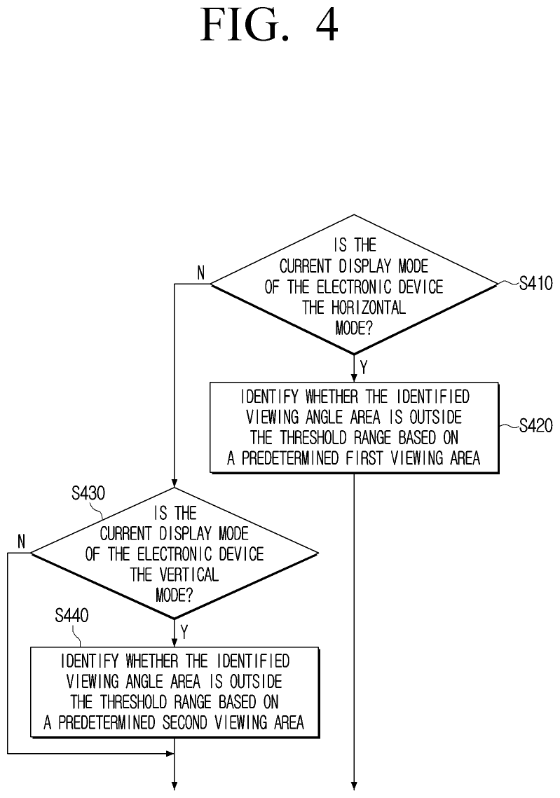

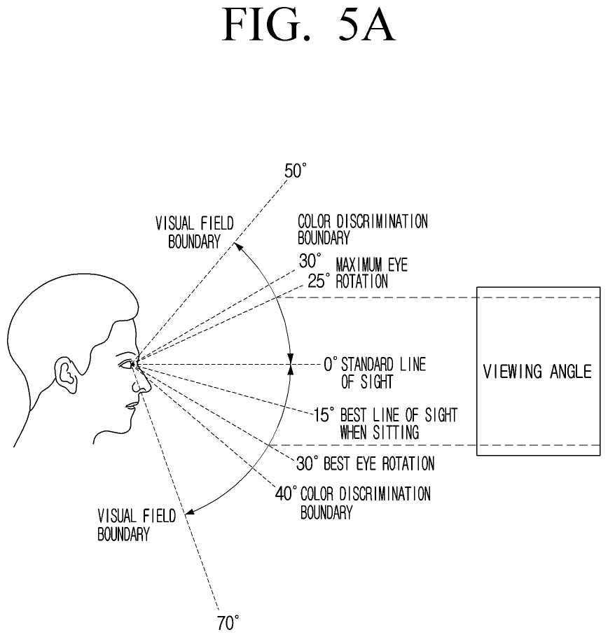

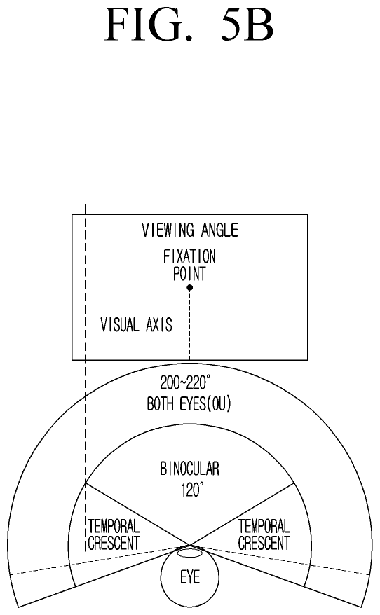

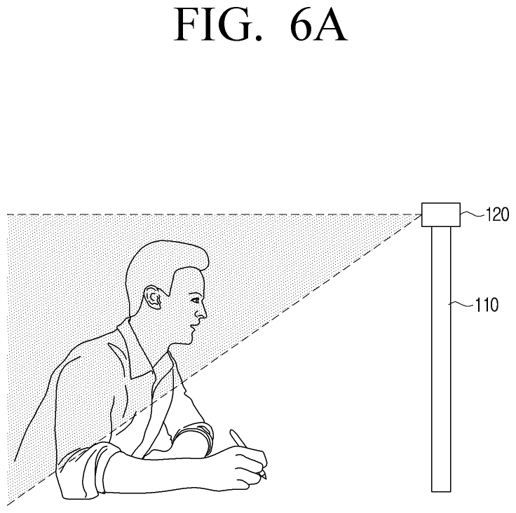

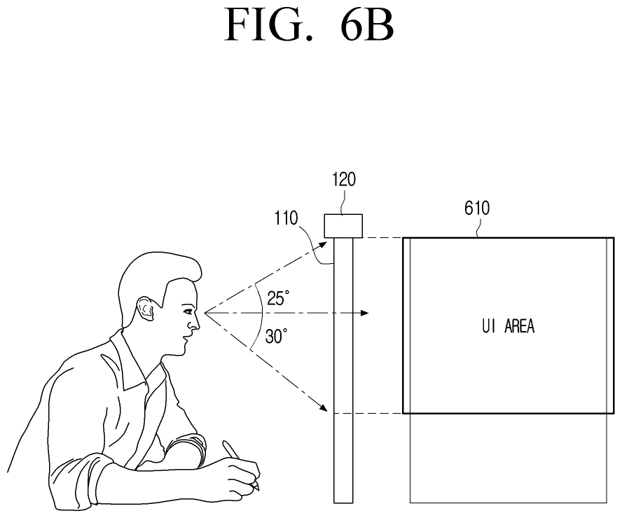

FIG. 4, FIG. 5A, and FIG. 5B are diagrams for illustrating a method of providing a UI screen according to an embodiment.

According to the embodiment illustrated in FIG. 4, if the current display mode is the vertical mode in the operation S410:Y, the processor 140 may identify whether the identified viewing angle area is outside the threshold range based on a predetermined first viewing area in the operation S420. Here, the predetermined first viewing area may be an area of a size wherein GUI items can be arranged without interfering with the UX experience of the user within the display area in the vertical mode. For example, as illustrated in FIG. 5A, according to a study, a general user may have a viewing angle of 25° in an upward direction and a viewing angle of 30° in a downward direction in the vertical direction. Accordingly, the processor 140 may identify a viewing angle area of the user based on the viewing angle of a general user in the vertical direction, and identify whether the identified viewing angle area is outside the predetermined first viewing angle area.

Meanwhile, if the current display mode is the horizontal mode in the operation S430:Y, the processor 140 may identify whether the identified viewing angle area is outside the threshold range based on a predetermined second viewing area in the operation S440. Here, the predetermined second viewing area may be an area of a size wherein GUI items can be arranged without interfering with the UX experience of the user within the display area in the horizontal mode. For example, as illustrated in FIG. 5B, according to a study, a general user may have a viewing angle of 144° in the horizontal direction. Accordingly, the processor 140 may identify a viewing angle area of the user based on the viewing angle of a general user in the horizontal direction, and identify whether the identified viewing angle area is outside the predetermined second viewing angle area. However, depending on cases, it may be possible that a user corrects and/or sets the predetermined first viewing angle and/or the predetermined second viewing angle that fits the user in advance in consideration of the body characteristics, the viewing posture, etc.

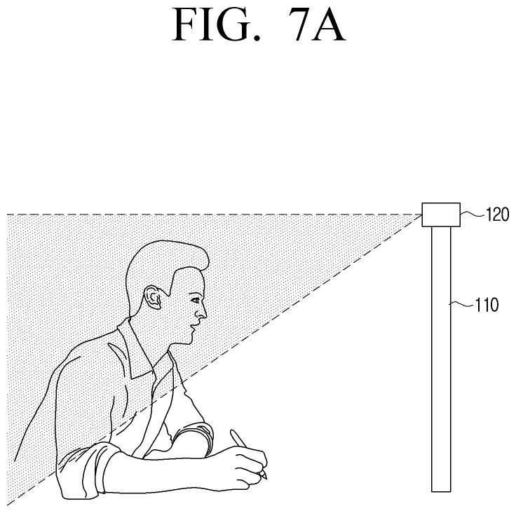

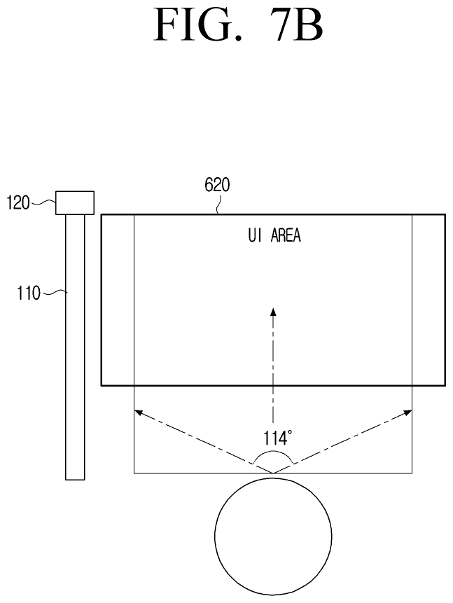

FIG. 6A, FIG. 6B, FIG. 7A, FIG. 7B, FIG. 8A and FIG. 8B are diagrams for illustrating a method of identifying a viewing angle of a user according to an embodiment.

According to the embodiment illustrated in FIG. 6A, in case a user is seated in front of the electronic device 100 wherein the display mode is the vertical mode, the processor 140 may capture the user by using the camera 120 arranged in the upper part of the display 110, and identify the position of the user's eyes and the distance between the electronic device 100 and the user based on the captured image. In this case, as in the embodiment illustrated in FIG. 6B, the processor 140 may identify an area of 25° in an upward direction and an area of 30° in a downward direction based on the position of the user's eyes as the viewing angle area 610.

According to the embodiment illustrated in FIG. 7A, in case a user is seated in front of the electronic device 100 wherein the display mode is the horizontal mode, the processor 140 may capture the user by using the camera 120 arranged in the upper part of the display 110, and identify the position of the user's eyes and the distance between the electronic device 100 and the user based on the captured image. In this case, as in the embodiment illustrated in FIG. 7B, the processor 140 may identify an area of 114° in left and right directions based on the position of the user's eyes as the viewing angle area 620.

According to the embodiment illustrated in FIG. 8A, in case the display mode is the vertical mode, and the camera 120 is not located in the center area of the upper part of the display 110, the processor 140 may identify the position of the user based on the captured image, and then identify the position of the user's eyes, and identify the distance from the user. For example, the processor 140 may calculate the distance from the user based on a front reference distance and the distance from the position of the user's eyes. Afterwards, the processor 140 may calculate a viewing angle based on the position of the user's eyes and the distance from the user.

According to the embodiment illustrated in FIG. 8B, a case wherein the position of the user's eyes and the distance from the user were calculated by using the camera 120 arranged in the center area of the upper part while the display mode is the horizontal mode, and then the display mode was changed to the vertical mode will be assumed. In this case, the processor 140 may identify a primary viewing angle based on the position of the user's eyes and the distance from the user that were obtained while the display mode is the horizontal mode, and then calculate a secondary viewing angle by the method illustrated in FIG. 8A to identify the final viewing angle based on an error range. For example, if the error range of the primary viewing angle and the secondary viewing angle is within n%, the processor 140 may identify the primary viewing angle as the final viewing angle, and if the error range exceeds n%, the processor 140 may identify an average value of the primary viewing angle and the secondary viewing angle as the final viewing angle. Here, n may be set as an appropriate value by an experiment.

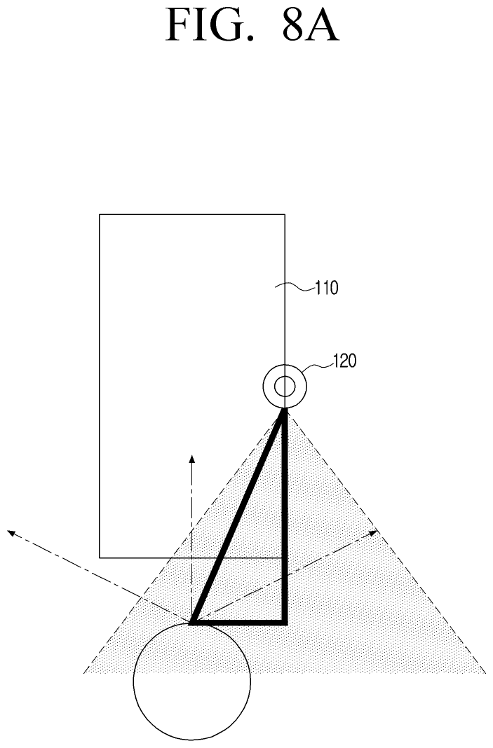

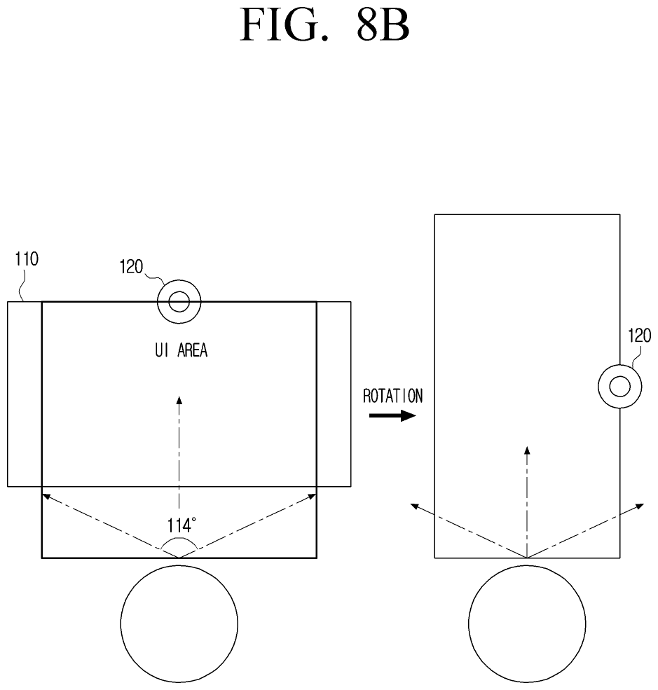

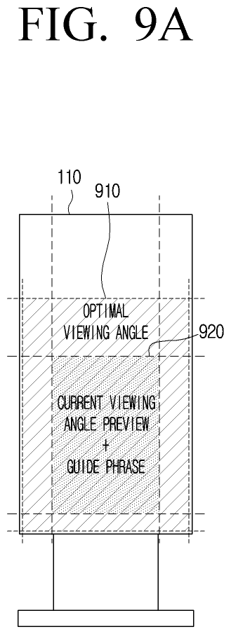

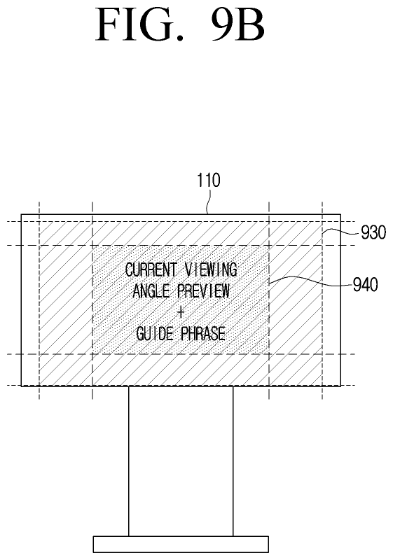

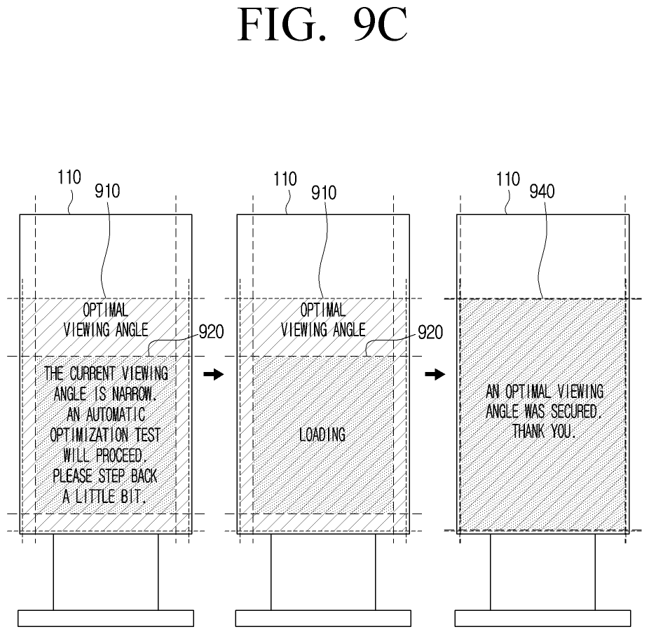

FIG. 9A to FIG. 9C are diagrams for illustrating a method of providing a guide UI according to an embodiment.

According to an embodiment, the processor 140 may provide a guide UI for a viewing angle test as described above.

According to an embodiment, in case a viewing angle area that was initially identified by recognizing the user in the vertical mode is not an optimal viewing angle area, the processor 140 may provide the optimal viewing angle area 910 and a preview screen 920 of the current viewing angle area. According to an embodiment, in case a viewing angle area that was initially identified by recognizing the user in the horizontal mode is not an optimal viewing angle area, the processor 140 may provide the optimal viewing angle area 930 and a preview screen 940 of the current viewing angle area. For example, the preview screens 920, 940 may include a guide phrase for adjustment of the viewing angle.

Here, the optimal viewing angle area may mean a state wherein the screen can be viewed as big as possible in the current display mode. According to an embodiment, the optimal viewing angle may be a viewing angle area in up-down/left-right directions calculated in the current position of the user's gaze based on a viewing distance of 50 cm, but is not necessarily limited thereto. For example, a viewing distance for calculation of an optimal viewing angle may be variable according to a screen size.

According to an embodiment, as illustrated in FIG. 9C, a preview screen 920 of the current viewing angle area including the position of the user and a guide for correcting the height of the stand may be provided in the vertical mode. In this case, a viewing angle area may be identified in real time whenever the position of the user is adjusted, and the preview screen 920 may be updated and provided. Afterwards, when the identified viewing angle 940 becomes close to the optimal viewing angle, i.e., when the error belongs within the threshold range, the viewing angle test may be completed. For example, if an error between the optimal viewing angle area and the current viewing angle area belongs within +−5%, the viewing angle test may be completed. When the viewing angle test is completed like this, a UI screen corresponding to the optimal viewing angle area can be provided.

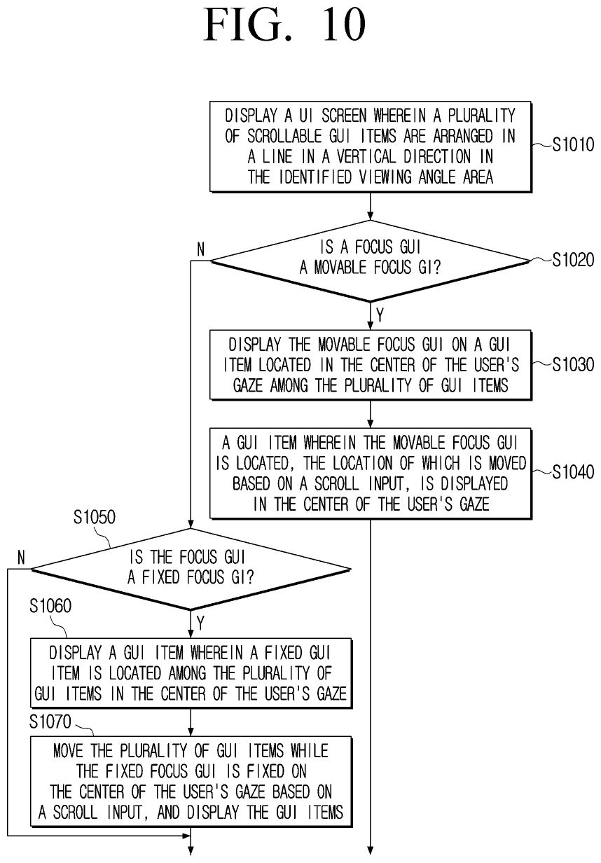

FIG. 10, FIG. 11A, and FIG. 11B are diagrams for illustrating a method of providing a UI screen according to an embodiment.

According to the embodiment illustrated in FIG. 10, the processor 140 may provide a UI screen wherein a plurality of scrollable GUI items are arranged in a line in a vertical direction in the identified viewing angle area in the operation S1010. Here, the identified viewing angle area may be an optimal viewing angle identified through the aforementioned viewing angle test, but is not necessarily limited thereto.

In case the focus GUI is a movable focus GI in the operation S1020, the processor 140 may control the display 110 such that the movable focus GUI is displayed on a GUI item located in the center of the user's gaze among the plurality of GUI items in the operation S1030. The movable focus GUI is an item for controlling scrolling of a list according to a movable focus method, and according to a scroll input, the movable focus GUI may be moved in one direction, and the GUI items included in the list may be moved in an opposite direction.

Then, the processor 140 may control the display 110 such that a GUI item wherein the movable focus GUI is located, the location of which is moved based on a scroll input, is displayed in the center of the user's gaze in the operation S1040.

For example, as illustrated in FIG. 11A, in case a UI screen wherein a plurality of scrollable GUI items are arranged in a line in a vertical direction is provided, when a viewing angle area of the user is identified, the processor 140 may arrange the plurality of GUI items in a line in a vertical direction within the identified viewing angle area and provide them, and provide a movable focus GUI 1110 in the center of the user's gaze. Also, the processor 140 may display a GUI item 5 wherein the movable focus GUI 1110 is located in the center of the user's gaze based on a scroll input.

Meanwhile, in case a focus GUI is a fixed focus GUI in the operation S1050:Y, the processor 140 may control the display 110 to display a GUI item wherein a fixed GUI item is located among the plurality of GUI items in the center of the user's gaze in the operation S1060. The fixed focus GUI is an item for controlling scrolling of a list according to a fixed focus method, and according to a scroll input, the location of the fixed focus GUI may be fixed and the GUI items included in the list may be moved in a scroll direction, and a new GUI item not provided on the UI screen may be provided on the UI screen.

Then, the processor 140 may control the display 110 to move the plurality of GUI items while the fixed focus GUI is fixed on the center of the user's gaze based on a scroll input, and display the GUI items in the operation S1070.

For example, as illustrated in FIG. 11B, in case a UI screen wherein a plurality of scrollable GUI items are arranged in a line in a vertical direction is provided, when a viewing angle area of the user is identified, the processor 140 may arrange the plurality of GUI items in a line in a vertical direction within the identified viewing angle area and provide them, and provide a fixed focus GUI 1120 in the center of the user's gaze. Also, the processor 140 may move the plurality of GUI items while the fixed focus GUI 1120 is fixed on the center of the user's gaze based on a scroll input, and display the GUI items.

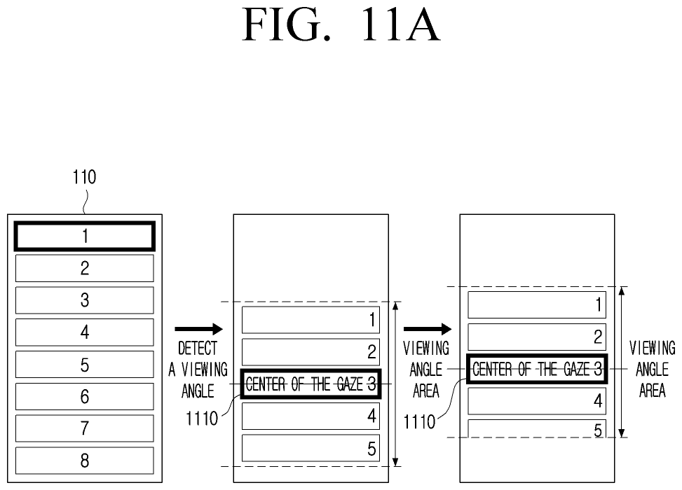

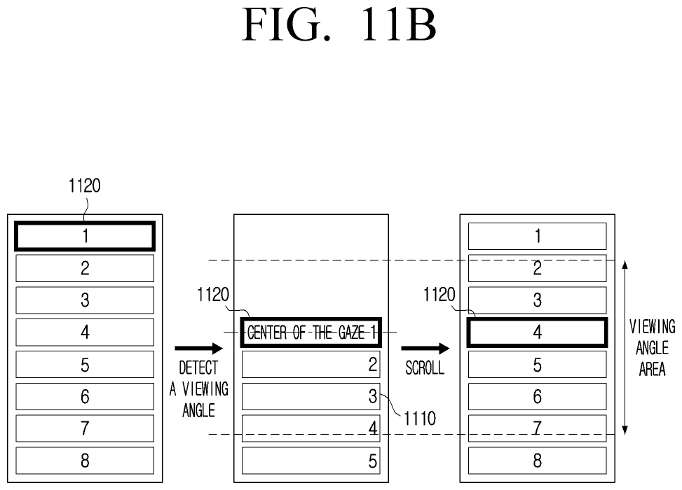

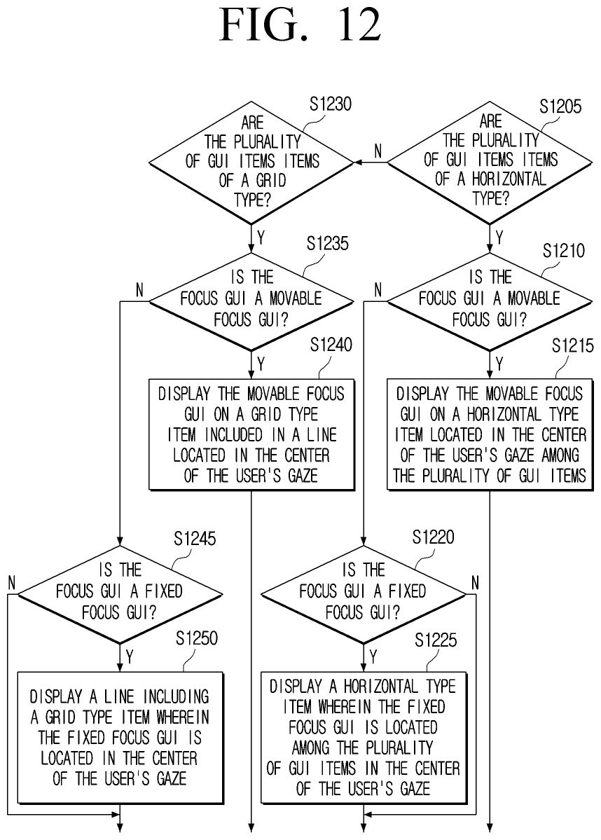

FIG. 12, FIG. 13A, and FIG. 13B are diagrams for illustrating a method of providing a UI screen according to an embodiment.

According to the embodiment illustrated in FIG. 12, in case the plurality of GUI items are items of a horizontal type in the operation S1205:Y, and the focus GUI is a movable focus GUI in the operation S1210:Y, the processor 140 may control the display 110 such that the movable focus GUI is displayed on a horizontal type item located in the center of the user's gaze among the plurality of GUI items in the operation S1215.

Also, in case the plurality of GUI items are items of a horizontal type in the operation S1205:Y, and the focus GUI is a fixed focus GUI in the operation S1220:Y, the processor 140 may control the display 110 such that a horizontal type item where the fixed focus GUI is located among the plurality of GUI items is displayed in the center of the user's gaze in the operation S1225.

In addition, in case the plurality of GUI items are items of a grid type in the operation S1230:Y, and the focus GUI is a movable focus GUI in the operation S1235:Y, the processor 140 may control the display 110 such that the movable focus GUI is displayed on a grid type item included in a line located in the center of the user's gaze in the operation S1240.

For example, as illustrated in FIG. 13A, in case a UI screen including a plurality of scrollable grid type GUI items 1311, 1312, 1313 . . . is provided, the processor 140 may provide a focus GUI 1310 on a GUI item 1313 included in a line located in the center of the gaze in the identified viewing angle area. For example, in case a scroll direction is from a left direction to a right direction, the processor 140 may provide the focus GUI 1310 on the first GUI item 1313 included in a line located in the center of the gaze.

Also, in case the plurality of GUI items are items of a grid type in the operation S1230:Y, and the focus GUI is a fixed focus GUI in the operation S1245:Y, the processor 140 may control the display 110 such that a line including a grid type item wherein the fixed focus GUI is located is displayed in the center of the user's gaze in the operation S1250.

For example, as illustrated in FIG. 13B, in case a UI screen including a plurality of scrollable grid type GUI items 1311, 1312, 1313 . . . is provided, the processor 140 may provide a line including the GUI item 1311 wherein the fixed focus GUI 1320 is located in the center of the user's gaze. For example, in case a scroll direction is from a left direction to a right direction, the fixed focus GUI 1320 may be provided to the first GUI item 1311 of the line.

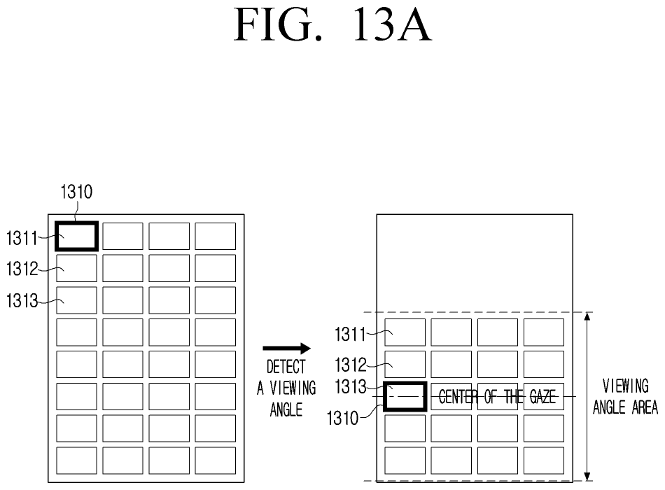

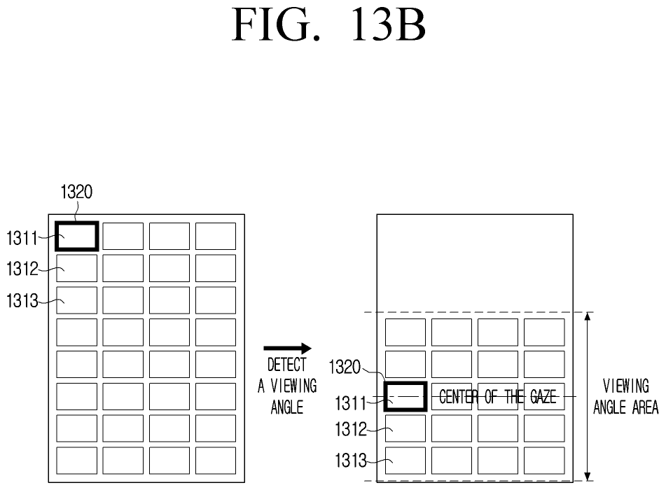

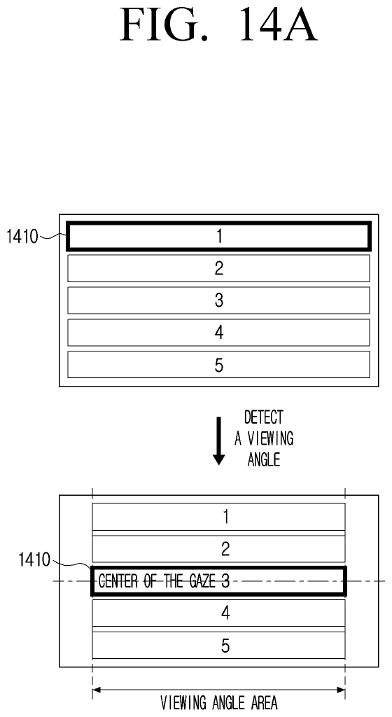

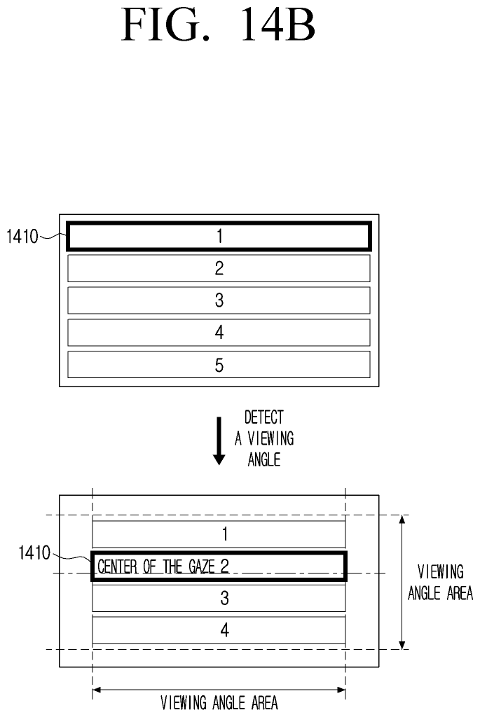

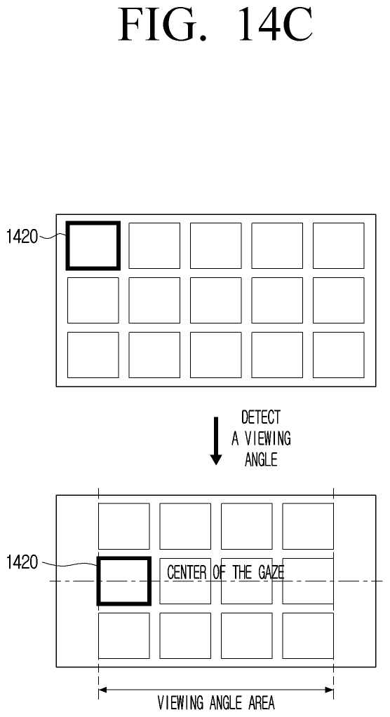

FIG. 14A to FIG. 14C are diagrams for illustrating a method of providing a UI screen according to an embodiment.

According to an embodiment, the processor 140 may not only adjust a focus position by reflecting a viewing angle of the user, but also adjust the overall UI ratio and display the UI screen.

For example, as illustrated in FIG. 14A, in case a UI screen including a plurality of scrollable horizontal type GUI items is provided, the processor 140 may adjust the horizontal width of the entire UI screen, i.e., reduce the width based on the identified viewing angle area and display the UI screen, and provide a focus GUI 1410 in the center of the gaze.

For example, as illustrated in FIG. 14B, in case a UI screen including a plurality of scrollable horizontal type GUI items is provided, the processor 140 may adjust not only the horizontal width but also the vertical width of the entire UI screen, i.e., reduce the widths based on the identified viewing angle area and display the UI screen, and provide a focus GUI 1410 in the center of the gaze.

For example, as illustrated in FIG. 14C, in case a UI screen including a plurality of scrollable grid type GUI items is provided, the processor 140 may adjust the horizontal width of the entire UI screen, i.e., reduce the width based on the identified viewing angle area and display the UI screen, and provide a focus GUI 1420 in the center of the gaze. Also, although not illustrated in the drawings, the processor 140 can obviously adjust not only the horizontal width but also the vertical width of the entire UI screen based on the identified viewing angle area and display the UI screen.

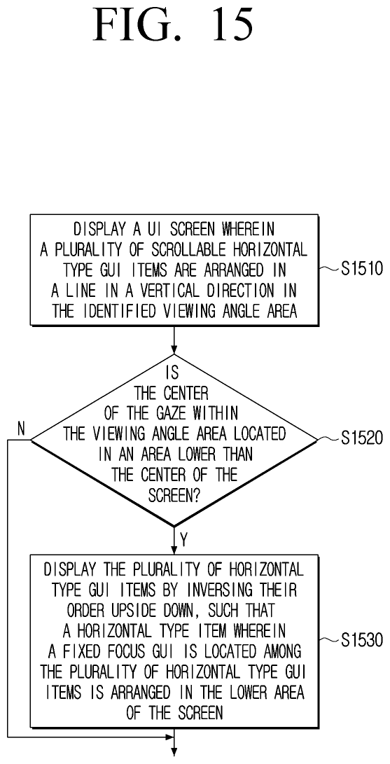

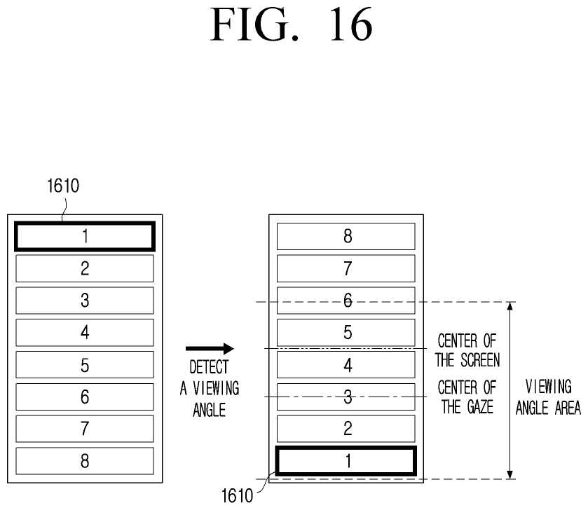

FIG. 15 and FIG. 16 are diagrams for illustrating a method of providing a UI screen according to an embodiment.

According to an embodiment, in case it is possible to scroll a plurality of GUI items included in a UI screen, but it is impossible to adjust the ratio and the size of the UI screen, and adjust the focus position, the processor 140 may provide the plurality of GUI items by changing their order.

According to FIG. 15, the processor 140 may display a UI screen wherein a plurality of scrollable horizontal GUI items are arranged in a line in a vertical direction in an identified viewing angle area in the operation S1510.

If the center of the gaze within the viewing angle area is located in an area lower than the center of the screen in the operation S1520:Y, the processor 140 may display the plurality of horizontal type GUI items by inversing their order upside down, such that a horizontal type item wherein a fixed focus GUI is located among the plurality of horizontal type GUI items is arranged in the lower area of the screen in the operation S1530.

For example, as illustrated in FIG. 16, if the center of the gaze within the viewing angle area is located in an area lower than the center of the screen, the processor 140 may provide the focus GUI 1610 in a location close to the center of the gaze by displaying the plurality of horizontal type GUI items by inversing their locations upside down. That is, in case it is impossible to adjust the ratio and the size of the UI screen, and adjust the focus position, the processor 140 may provide the focus GUI in a location close to the center of the gaze by changing the order of the plurality of GUI items.

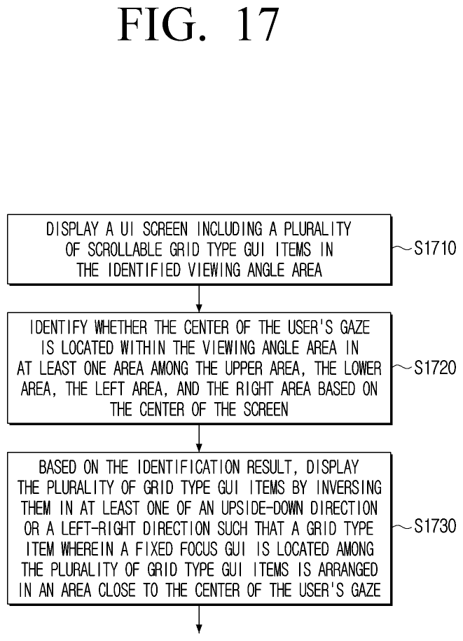

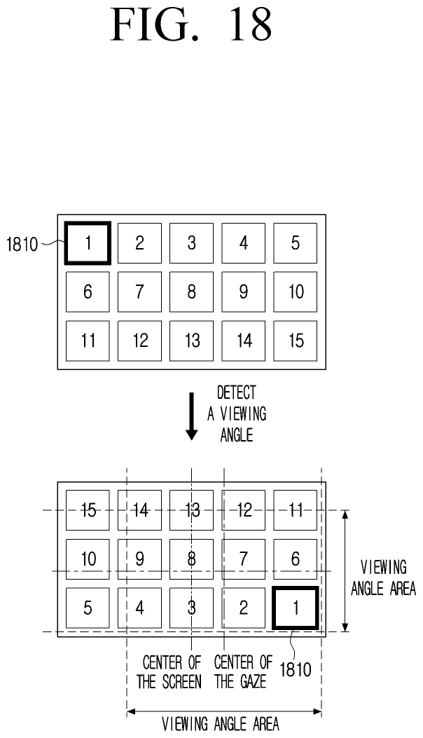

FIG. 17 and FIG. 18 are diagrams for illustrating a method of providing a UI screen according to an embodiment.

According to an embodiment, in case it is possible to scroll a plurality of GUI items included in a UI screen, but it is impossible to adjust the ratio and the size of the UI screen, and adjust the focus position, the processor 140 may provide the plurality of GUI items by changing their order.

According to FIG. 17, the processor 140 may display a UI screen including a plurality of scrollable grid type GUI items in an identified viewing angle area in the operation S1710.

The processor 140 may identify whether the center of the user's gaze is located within the viewing angle area in at least one area among the upper area, the lower area, the left area, and the right area based on the center of the screen in the operation S1720.

Then, based on the identification result, the processor 140 may display the plurality of grid type GUI items by inversing them in at least one of an upside-down direction or a left-right direction such that a grid type item wherein a fixed focus GUI is located among the plurality of grid type GUI items is arranged in an area close to the center of the user's gaze in the operation S1730.

For example, as illustrated in FIG. 18, if the center of the gaze within the viewing angle area is located in the lower/right area of the screen (e.g., the second quadrant based on the center of the screen), the processor 140 may provide the focus GUI 1810 in a location close to the center of the gaze by displaying the plurality of grid type GUI items by inversing their locations in upside-down and left-right directions. That is, in case it is impossible to adjust the ratio and the size of the UI screen, and adjust the focus position, the processor 140 may provide the focus GUI 1810 in a location close to the center of the gaze by changing the order of the plurality of GUI items.

For example, if the center of the gaze is located in the lower/left area of the center of the screen (e.g., the third quadrant based on the center of the screen), the processor 140 may display the plurality of grid type GUI items by inversing their locations upside down such that the initial focus is close to the center of the gaze. Also, if the center of the gaze is located in the upper/right area of the center of the screen (e.g., the first quadrant based on the center of the screen), the processor 140 may display the plurality of grid type GUI items by inversing their locations in a left-right direction such that the initial focus is close to the center of the gaze.

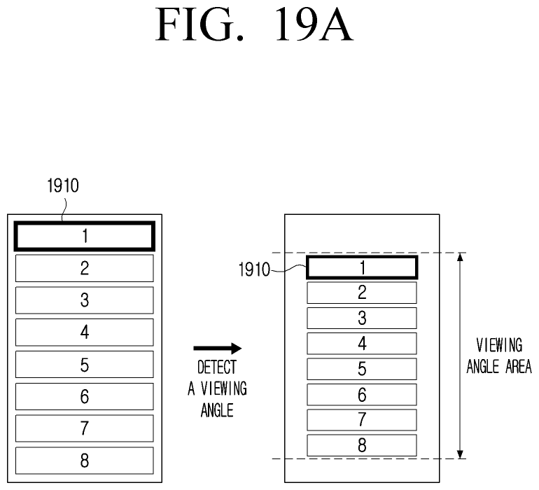

FIG. 19A and FIG. 19B are diagrams for illustrating a method of providing a UI screen according to an embodiment.

According to an embodiment, in case it is possible to scroll a plurality of GUI items included in a UI screen, but it is impossible to adjust the ratio of the UI screen, and adjust the focus position (however, in case the size can be changed), the processor 140 may display the UI screen by adjusting its size.

For example, as illustrated in FIG. 19A, in case the size of a viewing angle area is smaller than the size of a display area by n% (e.g., 80%), the processor 140 may adjust the entire size of a UI screen including horizontal type GUI items to be reduced to correspond to the viewing angle area and display the UI screen. In this case, it is obvious that the position of the focus 1910, rules such as upside-down inversion, etc. can be applied if needed.

For example, as illustrated in FIG. 19B, in case the size of a viewing angle area is smaller than the size of a display area by n% (e.g., 80%), the processor 140 may adjust the entire size of a UI screen including grid type GUI items to be reduced to correspond to the viewing angle area and display the UI screen. In this case, it is obvious that the position of the focus 1920, rules such as upside-down inversion/left-right inversion, etc. can be applied if needed.

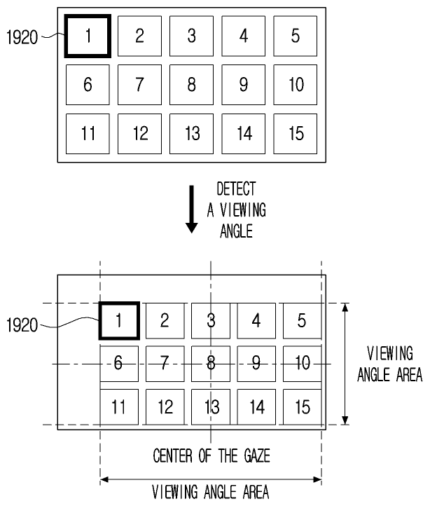

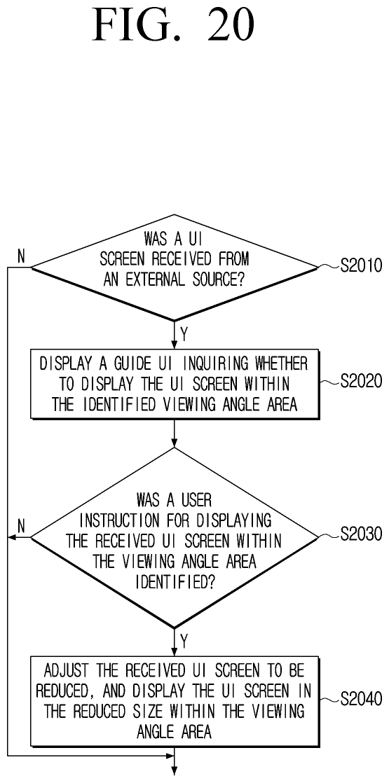

FIG. 20, FIG. 21A, and FIG. 21B are diagrams for illustrating a method of providing a UI screen according to an embodiment.

According to the embodiment illustrated in FIG. 20, if a UI screen is received from an external source in the operation S2010:Y, the processor 140 may display a guide UI inquiring whether to display the UI screen within an identified viewing angle area in the operation S2020.

Then, if a user instruction for displaying the received UI screen within the viewing angle area is identified in the operation S2030:Y, the processor 140 may adjust the received UI screen to be reduced, and display the UI screen in the reduced size within the viewing angle area in the operation S2040.

For example, as illustrated in FIG. 21A, in case a UI screen 2100 received from an external input device (e.g., a PC) is displayed, the processor 140 may provide a guide UI 2110 based on the viewing angle area. For example, the guide UI 2110 may include a guide phrase such as “Would you like the current screen to be displayed within the optimized viewing angle?”

If a user instruction (menu selection, a voice, a gesture, etc.) for displaying the received UI screen within the viewing angle area is identified based on the guide UI 2110, the processor 140 may display the UI screen (e.g., a PC screen) within the viewing angle area by reducing the screen as illustrated in FIG. 21A.

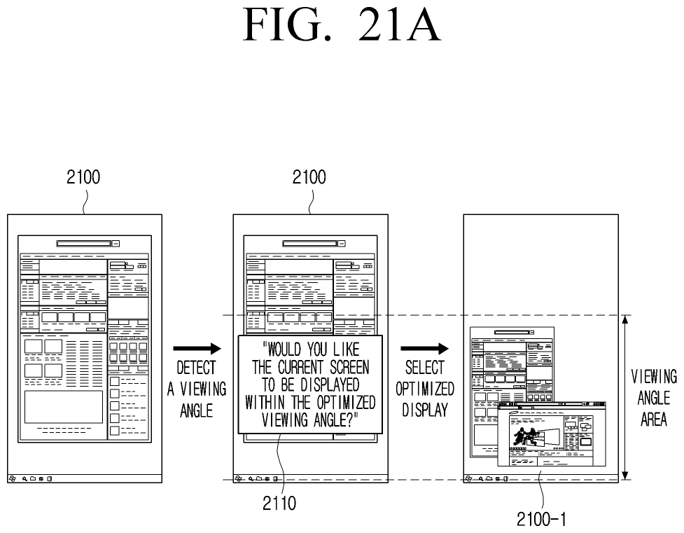

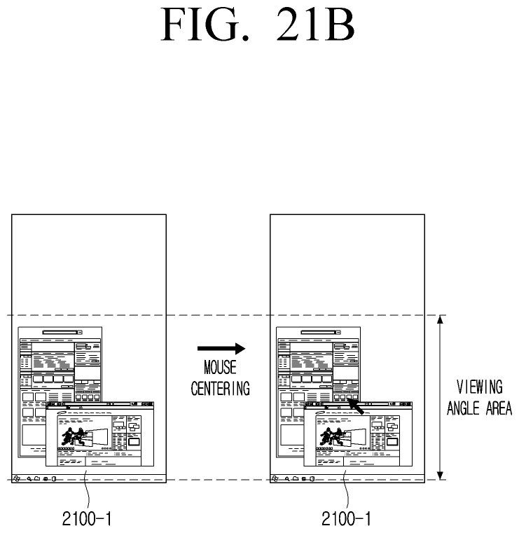

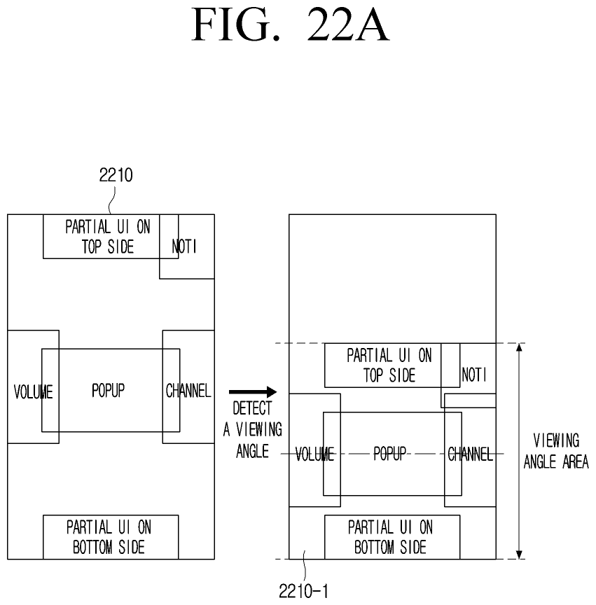

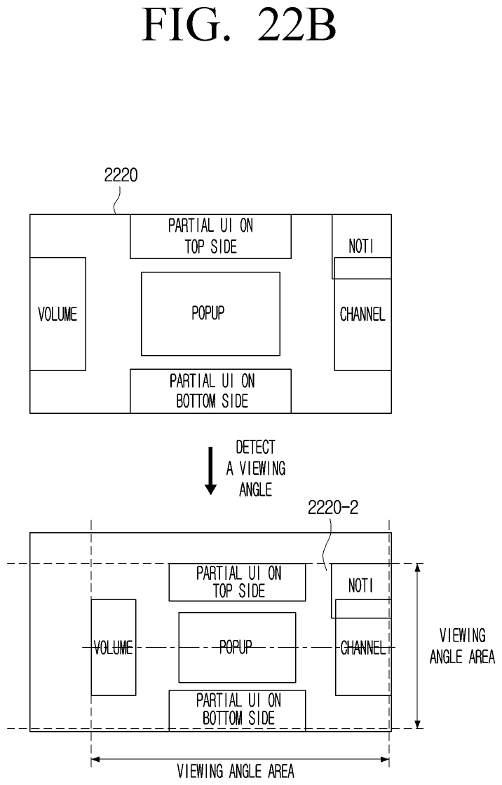

FIG. 22A and FIG. 22B are diagrams for illustrating a method of providing a UI screen according to an embodiment.

According to an embodiment, if a viewing angle area is identified while a UI screen including a plurality of partial UI items is being provided, the processor 140 may rearrange the plurality of partial UI items and display them within the identified viewing angle area.

For example, as illustrated in FIG. 22A, if a viewing angle area of the user is identified while a UI screen 2210 including a plurality of partial UI items is being provided in the vertical mode, the processor 140 may provide a UI screen 2210-1 wherein the plurality of partial UI items are rearranged to provide the UI screen 2210 in a size corresponding to the viewing angle area.

For example, as illustrated in FIG. 22B, if a viewing angle area of the user is identified while a UI screen 2220 including a plurality of partial UI items is being provided in the horizontal mode, the processor 140 may provide a UI screen 2220-1 wherein the plurality of partial UI items are rearranged to provide the UI screen 2220 in a size corresponding to the viewing angle area.

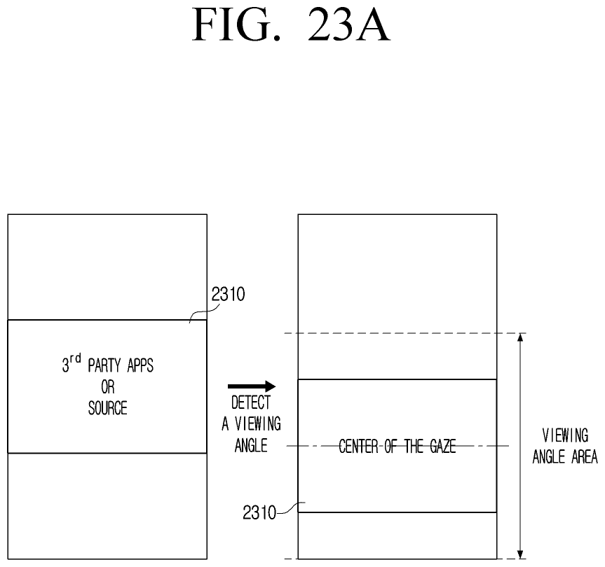

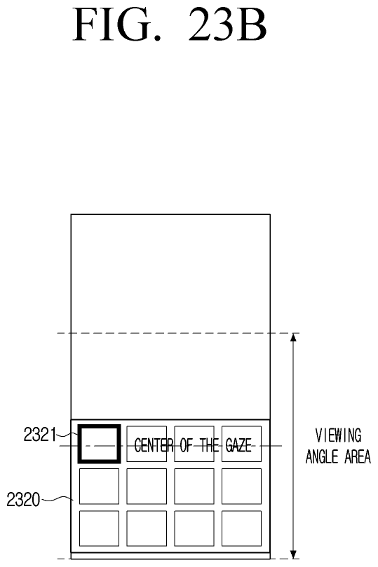

FIG. 23A and FIG. 23B are diagrams for illustrating a method of providing a UI screen according to an embodiment.

According to an embodiment, in the case of providing a UI wherein change of the ratio in a vertical form is impossible in the vertical mode, the processor 140 may provide the UI in a specific location in a viewing angle area while maintaining the ratio of the UI. For example, a UI provided from an application sticking to a specific ratio (e.g., 16:9) and/or a UI in a specific ratio provided from an external input source (e.g., a consol), etc. may fall under this.

For example, as illustrated in FIG. 23A, in case a UI screen 2310 in a form that is long in a horizontal direction needs to be provided in the vertical mode, the processor 140 may provide the UI screen 2310 in the center portion of an identified viewing angle area.

For example, as illustrated in FIG. 23B, in case a UI screen 2320 of a grid type that is long in a horizontal direction needs to be provided in the vertical mode, the processor 140 may provide the UI screen 2320 within an identified viewing angle area. Also, in case the UI 2320 includes a fixed focus GUI 2321, the processor 140 may provide the UI screen 2320 such that a GUI item wherein the fixed focus GUI 2321 is located is located in the center of the gaze within the viewing angle area.

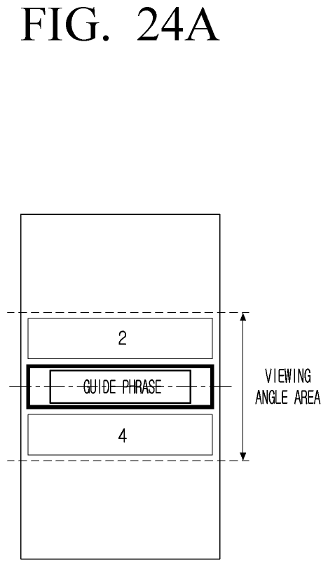

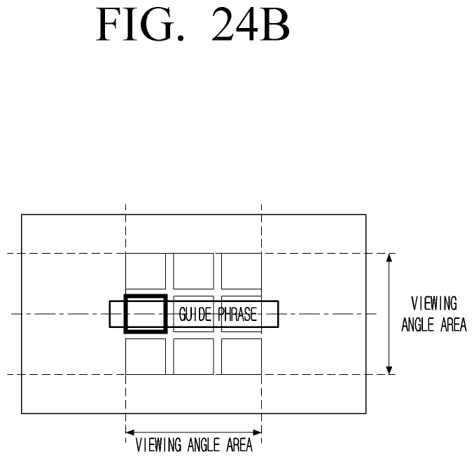

FIG. 24A and FIG. 24B are diagrams for illustrating a method of providing a guide UI according to an embodiment.

According to an embodiment, while a UI screen is provided in an identified viewing angle area, if it is identified that the identified viewing angle area is too small compared to the entire screen, the processor 140 may provide a guide UI on the UI screen.

For example, as illustrated in FIG. 24A, while a UI screen including horizontal type GUI items is provided in the vertical mode, if it is identified that the size of a viewing angle area, i.e., the UI screen provided in a viewing angle area is too small compared to the entire screen, the processor 140 may provide a guide UI on the UI screen. For example, in case the viewing angle area is smaller than or equal to n% compared to the entire screen, the processor 140 may determine that the size of the viewing angle area is too small. Here, n% may be set as different values for each screen size.

For example, as illustrated in FIG. 24B, while a UI screen including grid type GUI items is provided in the horizontal mode, if it is identified that the size of a viewing angle area, i.e., the UI screen provided in a viewing angle area is too small compared to the entire screen, the processor 140 may provide a guide UI on the UI screen. For example, in case the viewing angle area is smaller than or equal to n% compared to the entire screen, the processor 140 may determine that the size of the viewing angle area is too small. Here, n% may be set as different values for each screen size.

For example, the guide UI may include a guide phrase with the purport such as “Set an optimal viewing angle by correcting the posture and the location, and the height of the monitor.” According to an embodiment, in case a difference between the optimal viewing angle area and the identified viewing angle area is greater than or equal to a threshold value, or according to a user selection, it may be possible to re-proceed with a re-setting process of the viewing angle by moving to the viewing angle test stage described in FIG. 3.

According to the aforementioned various embodiments, viewing angle areas that are different for each user, each installation state, and each place can be automatically optimized and provided, and thus the user's convenience can be improved. Also, as main information and information of interest such as a focus GUI, etc. can be provided within a viewing angle area of the user, and main interactions may not be made to be outside the user's viewing angle, the user's UX experience can be improved.

Meanwhile, methods according to the aforementioned various embodiments of the disclosure may be implemented in forms of applications that can be installed on conventional electronic devices. Alternatively, the methods according to the aforementioned various embodiments of the disclosure, e.g., determination of an arrangement state of GUI items according to a viewing angle area may be performed by using an artificial neural network based on deep learning (or a deep artificial neural network), i.e., a learning network model.

Also, the methods according to the aforementioned various embodiment of the disclosure may be implemented just with software upgrade, or hardware upgrade for a conventional electronic device.

In addition, the aforementioned various embodiments of the disclosure may also be performed through an embedded server provided on an electronic device, or an external server of an electronic device.

Meanwhile, according to an embodiment of the disclosure, the aforementioned various embodiments may be implemented as software including instructions stored in machine-readable storage media, which can be read by machines (e.g.: computers). The machines refer to devices that call instructions stored in a storage medium, and can operate according to the called instructions, and the devices may include an electronic device according to the aforementioned embodiments (e.g.: an electronic device A). In case an instruction is executed by a processor, the processor may perform a function corresponding to the instruction by itself, or by using other components under its control. An instruction may include a code that is generated or executed by a compiler or an interpreter. A storage medium readable by machines may be provided in the form of a non-transitory storage medium. Here, the term ‘non-transitory’ only means that the storage medium does not include signals and is tangible, and the term does not distinguish a case wherein data is stored in the storage medium semi-permanently and a case wherein data is stored temporarily.

Also, according to an embodiment of the disclosure, the methods according to the aforementioned various embodiments may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or distributed on-line through an application store (e.g.: Play Store™). In the case of on-line distribution, at least a portion of a computer program product may be stored in a storage medium such as the server of the manufacturer, the server of the application store, and the memory of the relay server at least temporarily, or may be generated temporarily.

In addition, each of the components according to the aforementioned various embodiments (e.g.: a module or a program) may consist of a singular object or a plurality of objects, and among the aforementioned corresponding sub components, some sub components may be omitted, or other sub components may be further included in the various embodiments. Alternatively or additionally, some components (e.g.: a module or a program) may be integrated as an object, and perform functions performed by each of the components before integration identically or in a similar manner. Further, operations performed by a module, a program, or other components according to the various embodiments may be executed sequentially, in parallel, repetitively, or heuristically. Or, at least some of the operations may be executed in a different order or omitted, or other operations may be added.

Also, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed is:

1. An electronic device comprising:
a display that is rotatable;
a camera;
a memory to store at least one instruction; and
at least one processor, while connected with the display, the camera, and the memory, controls the electronic device to operate in one of a horizontal mode and a vertical mode by:
based on a captured image obtained through the camera, identify a distance between the electronic device and a user, and a gaze position of the user,
based on the distance between the electronic device and the user, and the gaze position of the user, identify a viewing angle area corresponding to a current display mode of the electronic device among display areas of the display, and
based on identifying that the identified viewing angle area is outside a threshold range based on a predetermined viewing angle area, control the display to display a guide user interface (UI) to allow for adjustment of the viewing angle area.

2. The electronic device of claim 1, wherein the predetermined viewing angle area is a predetermined first viewing area, and
wherein the at least one processor is configured to:
based on the current display mode of the electronic device being the horizontal mode, identify whether the identified viewing angle area is outside the threshold range based on the predetermined first viewing area, and
based on the current display mode of the electronic device being the vertical mode, identify whether the identified viewing angle area is outside the threshold range based on a predetermined second viewing area, and
the guide UI comprises:
a phrase guiding at least one of adjustment of a position of the user or adjustment of a height of a stand supporting the display.

3. The electronic device of claim 1,
wherein the at least one processor is configured to:
control the display to display a user interface (UI) screen which includes a plurality of scrollable graphic user interface (GUI) items that are arranged in a line in a vertical direction in the identified viewing angle area,
based on a focus GUI being a movable focus GI, control the display to display the movable focus GUI on a GUI item located in a center of the gaze position of the user among the plurality of GUI items, and
based on the focus GUI being a fixed focus GI, control the display to display a GUI item where a fixed GUI item is located among the plurality of GUI items in the center of the gaze position of the user.

4. The electronic device of claim 3,
wherein the at least one processor is configured to:
based on the focus GUI being a movable focus GI, control the display such that a GUI item where the movable focus GUI is located, which is moved based on a scroll input, is displayed in the center of the gaze position of the user, and
based on the focus GUI being a fixed focus GI, control the display to move the plurality of GUI items while the fixed focus GUI is fixed on the center of the gaze position of the user based on a scroll input, and display the plurality of GUI items.

5. The electronic device of claim 3,
wherein the at least one processor is configured to:
based on the plurality of GUI items being items of a horizontal type, control the display such that the movable focus GUI is displayed on a horizontal type item located in the center of the gaze position of the user among the plurality of GUI items, and control the display such that a horizontal type item wherein the fixed focus GUI is located among the plurality of GUI items is displayed in the center of the gaze position of the user, and
based on the plurality of GUI items being items of a grid type, control the display such that the movable focus GUI is displayed on a grid type item included in a line located in the center of the gaze position of the user, and control the display such that a line including a grid type item wherein the fixed focus GUI is located is displayed in the center of the gaze position of the user.

6. The electronic device of claim 1,
wherein the at least one processor is configured to:
control the display to display a UI screen including a plurality of scrollable horizontal type GUI items that are arranged in a line in a vertical direction in the identified viewing angle area, and
based on a center of the gaze position of the user within the viewing angle area being located in an area lower than the center of the screen, control the display to display the plurality of horizontal type GUI items by inversing an order thereof upside down, such that a horizontal type item where a fixed focus GUI is located among the plurality of horizontal type GUI items is arranged in the lower area of the screen.

7. The electronic device of claim 1,
wherein the at least one processor is configured to:
control the display to display a UI screen including a plurality of scrollable grid type GUI items in the identified viewing angle area,
identify whether a center of the gaze position of the user is located within the viewing angle area in at least one area among an upper area, a lower area, a left area, and a right area based on the center of the screen, and
based on a result of the identifying of the gaze position of the user, control the display to display the plurality of grid type GUI items by inversing the plurality of grid type GUI items in at least one of an upside-down direction or a left-right direction such that a grid type item wherein a fixed focus GUI is located among the plurality of grid type GUI items is arranged in an area close to the center of the gaze position of the user.

8. The electronic device of claim 1,
wherein the at least one processor is configured to:
adjust a size of a UI screen including a plurality of GUI items to be reduced based on the size of the identified viewing angle area, and
control the display to display the UI screen in a reduced size within the viewing angle area.

9. The electronic device of claim 1, further comprising:
a communication interface,
wherein the at least one processor is configured to:
based on receiving a UI screen from an external source through the communication interface, control the display to display a guide UI inquiring whether to display the UI screen within the identified viewing angle area,
based on identifying a user instruction for displaying the received UI screen within the viewing angle area, adjust the received UI screen to be reduced, and
control the display to display the UI screen in a reduced size within the viewing angle area.

10. The electronic device of claim 1,
wherein the at least one processor is configured to:
control the display to display a UI screen including a plurality of partial UI items, and
based on identifying the viewing angle area, control the display to rearrange the plurality of partial UI items and display them within the identified viewing angle area.

11. A method for providing a UI of an electronic device including a display that operates in one of a horizontal mode and a vertical mode, the method comprising:
based on a captured image obtained through a camera, identifying a distance between the electronic device and a user, and a gaze position of the user;
based on the distance between the electronic device and the user, and the gaze position of the user, identifying a viewing angle area corresponding to a current display mode of the electronic device among display areas of the display; and
based on identifying that the identified viewing angle area is outside a threshold range based on a predetermined viewing angle area, displaying a guide UI to allow adjustment of the viewing angle area.

12. The method for providing a UI of claim 11, wherein the predetermined viewing angle area is a predetermined first viewing angle area,
wherein the displaying the guide UI comprises:
based on the current display mode of the electronic device being the horizontal mode, identifying whether the identified viewing angle area is outside the threshold range based on the predetermined first viewing area; and
based on the current display mode of the electronic device being the vertical mode, identifying whether the identified viewing angle area is outside the threshold range based on a predetermined second viewing area, and
the guide UI comprises:
a phrase guiding at least one of adjustment of the position of the user or adjustment of a height of a stand supporting the display.

13. The method for providing a UI of claim 11, further comprising:
displaying a user interface (UI) screen wherein a plurality of scrollable graphic user interface (GUI) items are arranged in a line in a vertical direction in the identified viewing angle area;
based on a focus GUI being a movable focus GI, displaying the movable focus GUI on a GUI item located in a center of the gaze position of the user among the plurality of GUI items; and
based on the focus GUI being a fixed focus GI, displaying a GUI item wherein a fixed GUI item is located among the plurality of GUI items in the center of the gaze position of the user.

14. The method for providing a UI of claim 13, further comprising:
based on the focus GUI being a movable focus GI, displaying a GUI item wherein the movable focus GUI is located, the location of which is moved based on a scroll input, in the center of the gaze position of the user; and
based on the focus GUI being a fixed focus GI, moving the plurality of GUI items while the fixed focus GUI is fixed on the center of the gaze position of the user based on a scroll input, and displaying the GUI items.

15. A non-transitory computer-readable medium storing computer instructions which, when executed by a processor of an electronic device including a display that operates in one a horizontal mode and a vertical mode, causes the electronic device to perform an operation, comprising:
based on a captured image obtained through a camera, identifying a distance between the electronic device and a user, and a gaze position of the user;
based on the distance between the electronic device and the user, and the gaze position of the user, identifying a viewing angle area corresponding to a current display mode of the electronic device among display areas of the display; and
based on identifying that the identified viewing angle area is outside a threshold range based on a predetermined viewing angle area, displaying a guide UI to allow adjustment of the viewing angle area.

16. The non-transitory computer-readable medium as claimed in claim 15, wherein the predetermined viewing angle area is a predetermined first viewing angle area,
wherein the displaying the guide UI comprises:
based on the current display mode of the electronic device being the horizontal mode, identifying whether the identified viewing angle area is outside the threshold range based on the predetermined first viewing area; and
based on the current display mode of the electronic device being the vertical mode, identifying whether the identified viewing angle area is outside the threshold range based on a predetermined second viewing area, and
the guide UI comprises:
a phrase guiding at least one of adjustment of the position of the user or adjustment of a height of a stand supporting the display.

17. The non-transitory computer-readable medium as claimed in claim 15, the operation further comprising:
displaying a user interface (UI) screen wherein a plurality of scrollable graphic user interface (GUI) items are arranged in a line in a vertical direction in the identified viewing angle area;
based on a focus GUI being a movable focus GI, displaying the movable focus GUI on a GUI item located in a center of the gaze position of the user among the plurality of GUI items; and
based on the focus GUI being a fixed focus GI, displaying a GUI item wherein a fixed GUI item is located among the plurality of GUI items in the center of the gaze position of the user.

18. The non-transitory computer-readable medium as claimed in claim 17, the operation further comprising:
based on the focus GUI being a movable focus GI, displaying a GUI item wherein the movable focus GUI is located, the location of which is moved based on a scroll input, in the center of the gaze position of the user; and
based on the focus GUI being a fixed focus GI, moving the plurality of GUI items while the fixed focus GUI is fixed on the center of the gaze position of the user based on a scroll input, and displaying the GUI items.

19. The non-transitory computer-readable medium as claimed in claim 17, the operation further comprising:
based on the plurality of GUI items being items of a horizontal type, displaying the movable focus GUI on a horizontal type item located in the center of the gaze position of the user among the plurality of GUI items, and displaying a horizontal type item wherein the fixed focus GUI is located among the plurality of GUI items in the center of the gaze position of the user, and
based on the plurality of GUI items being items of a grid type, displaying the movable focus GUI on a grid type item included in a line located in the center of the gaze position of the user, and displaying a line including a grid type item wherein the fixed focus GUI is located in the center of the gaze position of the user.

20. The non-transitory computer-readable medium as claimed in claim 15, the operation further comprising:
displaying a UI screen including a plurality of scrollable horizontal type GUI items that are arranged in a line in a vertical direction in the identified viewing angle area, and
based on a center of the gaze position of the user within the viewing angle area being located in an area lower than the center of the screen, displaying the plurality of horizontal type GUI items by inversing an order thereof upside down, such that a horizontal type item where a fixed focus GUI is located among the plurality of horizontal type GUI items is arranged in the lower area of the screen.
